(19) United States
(12) Patent Application Publication
(10) Pub. No.: US 2026/0037642 A1
(43) Pub. Date: Feb. 5, 2026

(54) SYSTEMS AND METHODS FOR PROVIDING SYSTEM SECURITY USING A TRUST SCORE MANAGER

(71) Applicant: Axiado Corporation, San Jose, CA (US)

(72) Inventors: Raghu Kondapalli, San Jose, CA (US); Ayanava Chakraborty, San Jose, CA (US)

(21) Appl. No.: 19/273,571

(22) Filed: Jul. 18, 2025

Related U.S. Application Data
(60) Provisional application No. 63/677,546, filed on Jul. 31, 2024.

(51) Int. Cl. G06F 21/57

(52) U.S. Cl. CPC G06F 21/577; G06F 2221/034

(57) ABSTRACT

Described herein are systems and methods for monitoring suspicious activity by a trust score manager (TSM). The TSM identifies a transaction initiated by a master to access a region of the memory. The TSM also performs a scoring mechanism including mapping an identification of the master to a register. The TSM can ensure that only a master with dedicate access can access a region of the memory.

### CROSS-REFERENCE TO RELATED APPLICATIONS

This application claims the benefit of U.S. Provisional Application No. 63/677,546, filed Jul. 31, 2024, which is incorporated by reference herein in its entirety.

### BACKGROUND

Trust scoring generally refers to a evaluating or assigning a measure of trust (e.g., reliability or credibility) of a transaction or entity in a network. The scoring may be based on factors such as past transactions, reputation, or behavioral patterns. Trust scoring generally helps to improve network security by identifying trustworthy transactions or entities, and reducing the risk of malicious activity over a network. Still, further improvement in trust scoring are needed to help ensure secure and limited access to memory regions to maintain data integrity in the network.

### SUMMARY

Provided herein are computer-implemented methods of monitoring suspicious activity by a trust score manager (TSM) comprising: (a) identifying a transaction initiated by a master to access a region of a memory, wherein the master comprises a master identification (ID), and wherein each region of the memory comprises a dedicated master access managed in part by one or more software programmable registers of the TSM; (b) mapping the master ID to a software programmable register of the one or more software programmable registers; and (c) performing a scoring mechanism by TSM, wherein the scoring mechanism comprises changing an interface trust score (ITS) of the master ID, comprising: (i) incrementing the ITS if the software programmable register comprises an address of a memory region that is dedicated for access the master ID; and/or (ii) reducing the ITS if the software programmable register comprises an address of a memory region that is dedicated for access by another master ID. In some instances, the method further comprises initializing one or more trust score thresholds to one or more regions of the memory. In some instances, initializing the one or more trust score thresholds occurs prior to (b). In some instances, the method further comprises assigning one or more ITSs to one or more master IDs. In some instances, the assigning one or more ITSs occurs prior to (c). In some instances, the one or more ITSs are assigned on reset de-assertion. In some instances, one or more ITSs comprise the one or more trust score thresholds minus an integer value. In some instances, the integer value is 2. In some instances, the method further comprises notifying a secure processor if the ITS is less than a trust score threshold of the memory region. In some instances, the one or more trust score threshold comprises a 10-bit register. In some instances, the 10-bit register of a random value. In some instances, the random value is greater than or equal to 10′d1000. In some instances, the one or more software programmable registers comprise one or more start addresses or one or more end addresses of the one or more regions of the memory. In some instances, the one or more software programmable registers are programmed by a secure processor. In some instances, the master gains trust of the TSM over time.

Further provided herein are computer-implemented systems comprising: (a) a memory comprising one or more regions, wherein the one or more regions comprise one or more addresses; and (b) at least one processor providing a trust score manager (TSM), wherein the TSM comprises: (i) one or more software programmable registers corresponding to the one or more addresses; (ii) one or more trust score threshold for the one or more memory regions; and (iii) one or more interface trust scores for one or more master identifications (IDs). In some instances, the one or more addresses comprise one or more start addresses, one or more end addresses, or both of the one or more memory regions. In some instances, the TSM performs at least one operation, wherein the at least one operation comprises one or more of: (A) identifying a transaction initiated by a master to access a memory region, wherein the master comprises a master identification (ID); (B) initializing the one or more trust score thresholds on reset de-assertion; (C) assigning the one or more interface trust scores (ITSs) on reset de-assertion; (D) mapping the master ID to a software programmable register of the one or more software programmable registers; (E) performing a scoring mechanism when the transaction is initiated; and (F) notifying a secure processor if an interface trust score of the master ID is less than a trust score threshold of a memory region that the master is trying to access. In some instances, the one or more trust score thresholds comprises a random value. In some instances, the random value is greater than or equal to 10′d1000. In some instances, the one or more ITSs comprise the one or more trust score thresholds minus an integer value. In some instances, the integer value is 2. In some instances, the scoring mechanism comprises changing an ITS of the master ID, wherein changing the ITS comprises: (1) incrementing the ITS if the software programmable register comprises an address of a memory region that is dedicated for access the master ID; or (2) reducing the ITS if the software programmable register comprises an address of a memory region that is dedicated for access by another master ID. In some instances, the master comprises a CPU.

Further provided herein are non-transitory computer-readable storage media encoded with instructions executable by one or more processors to provide an application for monitoring suspicious activity by performing operations comprising: identifying a transaction initiated by a master to access a region of a memory, wherein the master comprises a master identification (ID), and wherein each region of the memory comprises a dedicated master access managed in part by one or more software programmable registers of a trust score manager (TSM); mapping the master ID to a software programmable register of the one or more software programmable registers; and performing a scoring mechanism by the TSM, wherein the scoring mechanism comprises changing an interface trust score (ITS) of the master ID, comprising: incrementing the ITS when the software programmable register comprises an address of a memory region that is dedicated for access the master ID; or reducing the ITS when the software programmable register comprises an address of a memory region that is dedicated for access by another master ID. In some instances, the operations further comprise initializing one or more trust score thresholds to one or more regions of the memory. In further instances, initializing the one or more trust score thresholds occurs prior to the mapping. In some instances, the operations further comprise assigning one or more ITSs to one or more master IDs. In further instances, the assigning one or more ITSs occurs prior to the performing the scoring mechanism. In some instances, the one or more ITSs are assigned on reset de-assertion. In some instances, one or more ITSs comprise the one or more trust score thresholds minus an integer value. In some instances, the integer value is 2. In some instances, the operations further comprise notifying a secure processor if the ITS is less than a trust score threshold of the memory region. In further instances, the one or more trust score threshold comprises a 10-bit register. In still further instances, the 10-bit register of a random value. In some instances, the random value is greater than or equal to 10′d1000. In some instances, the one or more software programmable registers comprise one or more start addresses or one or more end addresses of the one or more regions of the memory. In some instances, the one or more software programmable registers are programmed by a secure processor. In some instances, the master gains trust of the TSM over time.

### BRIEF DESCRIPTION OF THE DRAWINGS

A better understanding of the features and advantages of the present subject matter will be obtained by reference to the following detailed description that sets forth illustrative embodiments and the accompanying drawings of which:

FIG. 1 shows a non-limiting example of a schematic illustrating a trust score manager that resides near a memory that is accessed by a master, according to some embodiments;

FIG. 2 shows a non-limiting example of a schematic illustrating a trust score manager comprising one or more software programmable registers with start and end addresses of one or more regions of a dynamic random-access memory (DRAM), according to some embodiments;

FIG. 3 shows a non-limiting example of a schematic illustrating one or more operations performed by a trust score manager, according to some embodiments;

FIG. 4 shows a non-limiting example of a schematic illustrating a method for providing deice security using a trust score manager, according to some embodiments; and

FIG. 5 shows a non-limiting example of a computing device; in this case, a device with one or more processors, memory, storage, and a network interface.

### DETAILED DESCRIPTION

Provided herein are systems and methods for monitoring activity. In some instances, the systems and methods provided herein monitor suspicious activity. In some instances, the systems and methods provided herein monitor activity by keeping track of masters with any suspicious activity. In some instances, the systems and methods provided herein monitor activity, ensuring that only certain masters (e.g., CPUs) can access a memory. In some instances, the systems and methods provided herein ensure that only a certain master (e.g., CPU) can access a region of a memory. In some instances, ensuring dedicated access of a memory region by a master provides increased security, stability, or reliability of a system. For example, by ensuring that only a certain master can access a memory region, the memory region may not be modified inadvertently or by a malicious actor, thus maintaining data integrity. In some instances, ensuring dedicated access of a memory region by a master optimizes device performance of a system or increases efficiency across a system. In some instances, ensuring dedicated access of a memory region by a master simplifies debugging or provides a controlled environment by allocating resources.

Provided herein are methods and systems comprising a trust score manager (TSM) for monitoring activity. A system may generally comprise a memory and at least one processor providing the TSM. In some instances, the memory comprises one or more memory regions. The one or more memory regions may comprise one or more addresses, including start addresses, end addresses, or both. In some instances, the TSM comprises one or more programmable registers, one or more trust score thresholds, one or more interface trust scores, or any combination thereof. In some examples, the one or more software programmable registers correspond to the one or more addresses. In some examples, the one or more trust score threshold(s) are for the one or more memory regions. In some examples, the one or more interface trust scores are for the one or more master IDs. In some cases, the TSM protects the memory from initial boot and cuts of any bad access if required in order to prevent data corruption. In some cases, the TSM works as a line of defense to protect a memory module. In some instances, the TSM works as the last line of defense to protect a memory module.

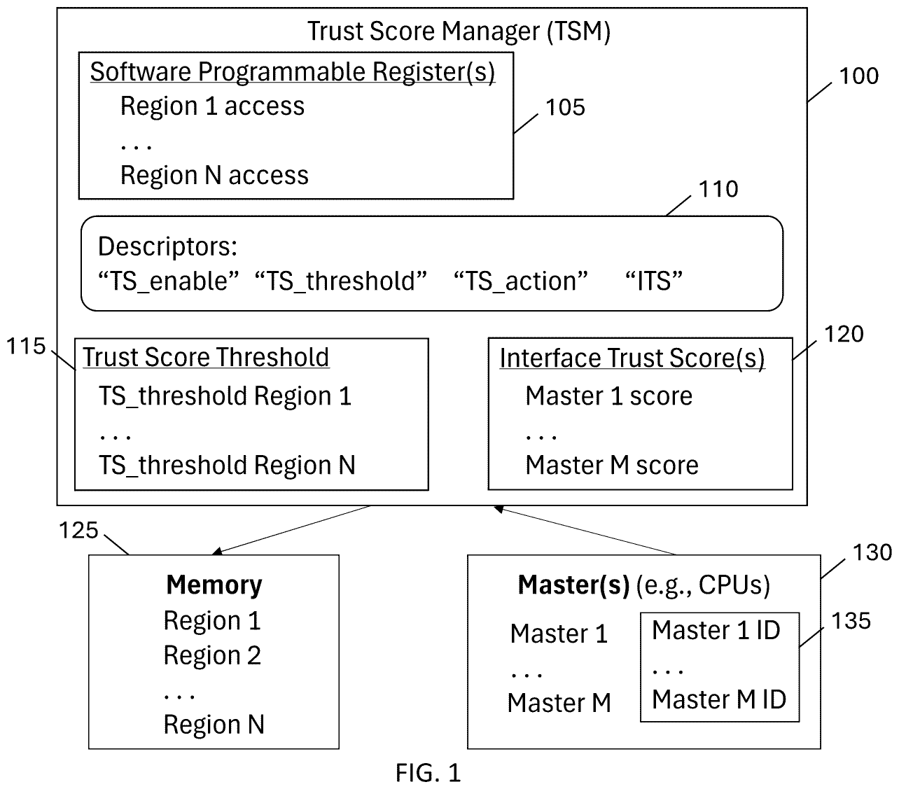

An exemplary schematic illustrating a system comprising a TSM is provided in FIG. 1. In some instances, a trust score manager 100 comprises one or more software programmable registers 105. The one or more software programmable registers can comprise, in some instances, one or more addresses. The one or more addresses may correspond to one or more start addresses or one or more end addresses of regions of the memory. For example, if the memory is subdivided into N regions, where each region comprises a start address and an end address, then the one or more software programmable registers can comprise the start address and end address of the N regions of the memory.

The trust score manager may comprise one or more descriptors 110. In some cases, the one or more descriptors 110 comprise one or more of: trust score enable (“TS_enable”), trust score threshold (“TS_threshold”), trust score action (“TS_action”), or interface trust scores (“ITSs”). In some cases, the one or more descriptors holds a binary value. In some cases, the one or more descriptors comprise a 1, 2, 3, 4, 5, 6, 7, 8, 9, 10, 11, 12, 13, 14, 15, 16, 17, 18, 19, or 20 bit value. In some cases, the one or more descriptors comprise a 1-2, 1-5, 1-10, 1-15, 1-20, 2-5, 2-10, 3-5, 3-10, 3-12, 5-10, 5-15, 5-20, 8-12, 8-15, 8-20, 10-15, 10-20, 15-18, 15-20, or 18-20 bit value. In some instances, TS_enable comprises a control signal indicating which regions of the memory are enabled for the TSM. In some examples, the control signal is programmed by a secure processor. In some instances, TS_enable comprises a control signal dedicated for each region that is programmed by the secure processor. In some examples, the control signal comprises a 1-bit control signal. In some instances, TS_threshold comprises trust score thresholds for one or more memory regions. In some instances, TS_threshold comprises trust score thresholds for some or all of the memory regions. In some examples, the TS_threshold comprises 10-bit data assigned to one or more regions of the memory. For example, trust score thresholds 115 comprise 10-bit data assigned to each of the N regions of the memory. In some examples, registers are uninitialized and at time 0, the registers are initialized with random values, referred to as TS_threshold. The TSM logic can ensure that the TS_threshold value is not less a value. In some examples, the value is 10′d1000. In some examples, the value is predetermined. In some examples, the value is constant across some or all of the one or more memory regions. In some instances, TS_action indicates what type of action should be taken against a master on each transaction made by it. In some examples, TS_action comprises a 2-bit value. In some instances, the ITSs 120 comprise scores of some or all master interfaces. In some examples, an ITS comprises a 10-bit value.

In some cases, a memory 125 is subdivided into one or more regions. A memory may comprise, in some instances, a memory comprising a random access memory component (e.g., static RAM (SRAM), dynamic RAM (DRAM), ferroelectric random access memory (FRAM), phase-change random access memory (PRAM), etc.), or a read-only memory component. In some instances, each of the one or more regions comprises a dedicated master access (e.g., dedicated CPU access). In such instances, a master cannot access regions of the memory other than the dedicated region. In some cases, the TSM resides near the memory to prevent data corruption. In some embodiments, the memory is subdivided into N regions. In some cases, the N regions are the same size. In some cases, the N regions vary in size. In some cases, N comprises 1, 2, 3, 4, 5, 6, 7, 8, 9, 10, 11, 12, 13, 14, 15, 16, 18, 20, 25, 30, 35, 40, 50, 60, 70, 80, 90, or 100, including increments therein. In some cases, N is at least 1, 2, 3, 4, 5, 6, 7, 8, 9, 10, 11, 12, 13, 14, 15, 16, 18, 20, 25, 30, 35, 40, 50, 60, 70, 80, 90, or 100, including increments therein. In some cases, N is no more than 1, 2, 3, 4, 5, 6, 7, 8, 9, 10, 11, 12, 13, 14, 15, 16, 18, 20, 25, 30, 35, 40, 50, 60, 70, 80, 90, or 100, including increments therein. In some cases, N comprises about 1-5, 1-10, 2-5, 2-8, 2-10, 5-10, 5-15, 10-20, 10-25, 10-40, 15-20, 15-30, 20-40, 20-50, 30-60, 30-80, 30-100, 40-60, 40-80, 40-100, 50-80, 50-100, 60-80, 60-100, 70-100, 80-100, or 90-100. In some cases, each region of the memory comprises at least one address. In some cases, each region of the memory comprises at least two addresses. In some cases, each region of the memory comprises two addresses. In some instances, the two addresses comprise a start address and an end address.

In some cases, one or more masters 130 initiates a transaction. In some instances, the memory is accessed by one or more masters M. In some examples, M comprises 1, 2, 3, 4, 5, 6, 7, 8, 9, 10, 11, 12, 13, 14, 15, 16, 18, 20, 25, 30, 35, 40, 50, 60, 70, 80, 90, or 100, including increments therein. In some examples, M is at least 1, 2, 3, 4, 5, 6, 7, 8, 9, 10, 11, 12, 13, 14, 15, 16, 18, 20, 25, 30, 35, 40, 50, 60, 70, 80, 90, or 100, including increments therein. In some examples, M is no more than 1, 2, 3, 4, 5, 6, 7, 8, 9, 10, 11, 12, 13, 14, 15, 16, 18, 20, 25, 30, 35, 40, 50, 60, 70, 80, 90, or 100, including increments therein. In some cases, M comprises about 1-5, 1-10, 2-5, 2-8, 2-10, 5-10, 5-15, 10-20, 10-25, 10-40, 15-20, 15-30, 20-40, 20-50, 30-60, 30-80, 30-100, 40-60, 40-80, 40-100, 50-80, 50-100, 60-80, 60-100, 70-100, 80-100, or 90-100. The one or more masters are tagged with a unique ID, referred to as a master ID 135, in order for TSM to identify the initiator of the data transaction. In some instances, if a transaction is initiated from a master 130 to a memory 125, the TSM 100 maps the master ID 135 with a configured start and/or end address of the respective master to know if it is a good or a bad access from the given master. In some embodiments, the master is a CPU. In some embodiments, the unique ID depends in part on the manufacturer or the specific model of a CPU. In some cases, a unique ID comprises a multi-bit value (e.g., 2-bit, 4-bit, 8-bit, 16-bit, 32-bit, 64-bit value). In some cases, a unique ID comprises a hexadecimal representation.

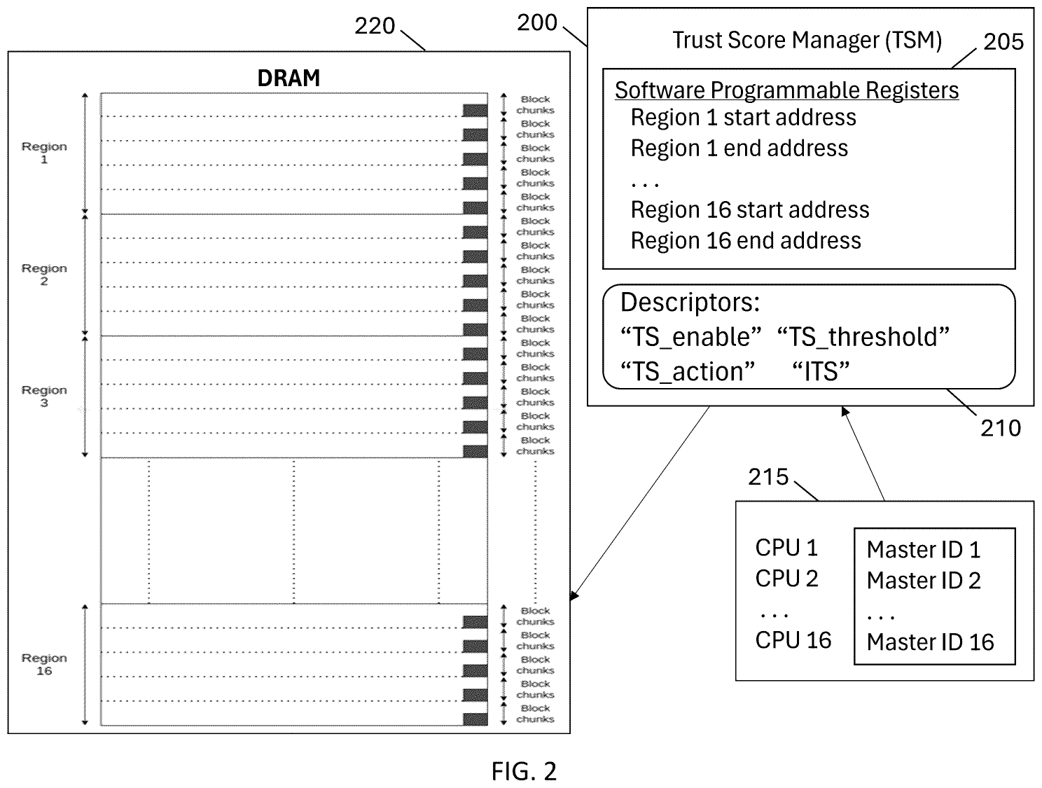

An exemplary schematic illustrating a TSM managing access of a DRAM by a master (e.g., a CPU) is provided in FIG. 2. A CPU 215 may initiate a transaction that is managed by the TSM 200. The TSM can comprise one or more software programmable registers with start and end addresses 205 of one or more regions of a memory, such as for example, a dynamic random-access memory (DRAM) 220. In some instances, the TSM comprises descriptors 210, including by way of non-limiting example: trust score enable (“TS_enable”), trust score threshold (“TS_threshold”), trust score action (“TS_action”), or interface trust scores (“ITSs”). As an example, the DRAM is divided into 16 regions accessed by 16 separate masters, as shown in FIG. 2. In some examples, each master has access to its respective region. In some examples, a master is not allowed to access a region beyond the respective region. For example, referring to FIG. 2, CPU1 (with master ID 1) can only access Region 1 of the DRAM, and not any one of Regions 2 through 16. In some embodiments, a region is accessed by at least one master. In some embodiments, a region is accessed by more than one master. For example, two or more masters (CPUs) may access a given region of a memory.

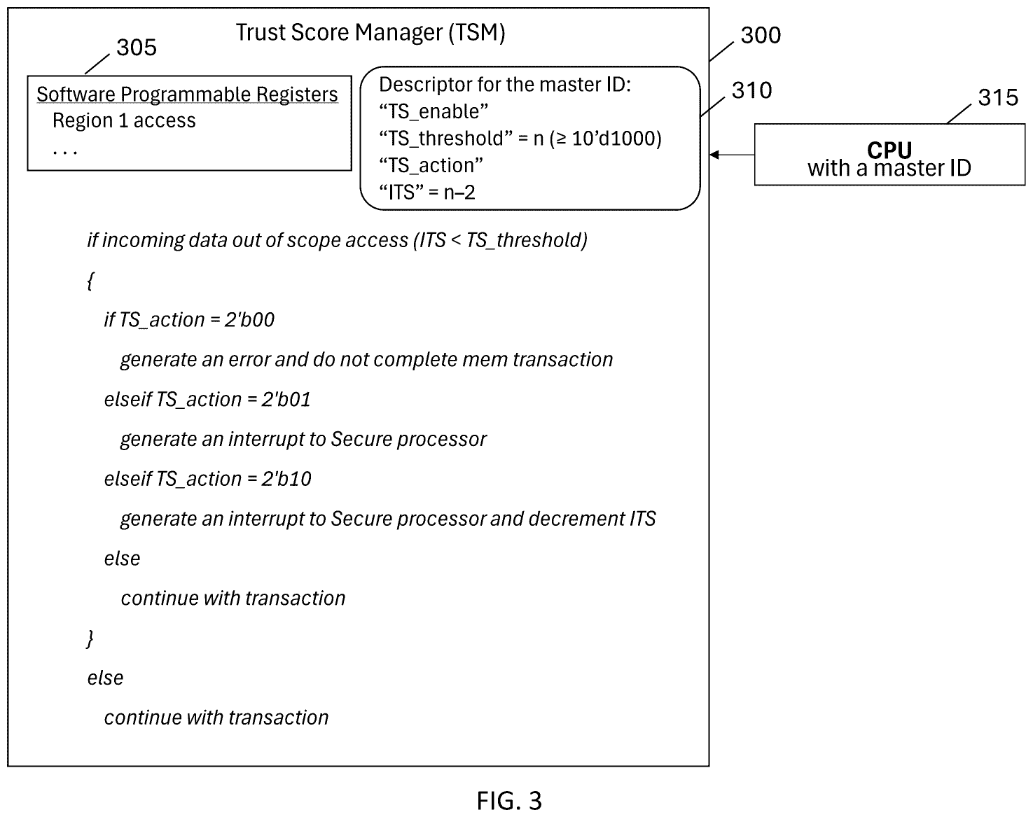

The TSM may perform at least one operation when a memory is accessed by a master. For example, as shown in FIG. 3, the at least one operation of the TSM 300 can comprise identifying a transaction to access a memory region initiated by a master 315. The master can comprise a master ID, as described herein. In some examples, the at least one operation comprises, on reset de-assertion, initializing the one or more trust score thresholds (“TS_threshold”). As shown in FIG. 3, the trust score threshold can comprise a random value 310. In some instances, the random value is greater than or equal to a value. In some examples, the value is 10′d1000 (e.g., n≥10′d1000). In some examples, the at least one operation comprises, on reset de-assertion, assigning one or more interface trust scores (“ITSs”) 310. In some examples, an interface trust score is assigned to each of the masters. In some instances, the assigned interface trust score is less than a trust score threshold. The ITS of a master may generally comprise the trust score threshold for the memory region of dedicated access minus an integer value. In some examples, the integer comprises 1, 2, 3, 4, 5, or 6. In some examples, the integer comprises 2. For example, if a first region (e.g., Region 1) of the memory is enabled with TSM, which is dedicated for a CPU (e.g., CPU1), on reset de-assertion, the region is initialized with a 10-bit TS_threshold value n. In some examples, the ITS for the CPU is assigned a value of n minus 2.

The TSM may trust a master in part based on the ITS, TS_threshold, or both. In some cases, when an ITS is less than the TS_threshold, a TSM does not trust the master (e.g., CPU). In some cases, when an ITS is greater than the TS_threshold, a TSM trusts the master (e.g., CPU). In some cases, at an initial stage, the ITS is less than the TS_threshold. In such cases, the TSM does not trust the master (e.g., CPU). In some instances, when a master accesses a dedicated memory region, the ITS is incremented. In some examples, the ITS is incremented by an integer value (e.g., incremented by 1). In some instances, when a master accesses a region other than the dedicated memory region, the ITS is reduced. In some examples, the ITS is reduced by an integer value (e.g., reduced by 1).

In some cases, the at least one operation of the TSM 300 comprises a scoring mechanism. A scoring mechanism may generally comprise mapping a master ID from the CPU 315 to a software programmable register 305. A scoring mechanism may also comprise changing an ITS of the master ID. In some instances, changing the ITS comprises incrementing or decrementing the ITS. In some examples, changing the ITS comprises incrementing the ITS if the software programmable register comprises an address of a memory region that is dedicated for access the master ID. In some instances, changing the ITS comprises reducing the ITS if the software programmable register comprises an address of a memory region that is dedicated for access by another master ID. In some instances, if the CPU tries to access a memory region dedicated for access by another master, the TSM notifies the secure processor. In some examples, during the bring up, none of the interfaces are trusted. In some instances, at least some of the masters gain trust of the TSM over time. In some instances, some or all of the masters gain trust of the TSM over time.

The TSM may take different actions based on the transaction. An exemplary pseudo code is provided in FIG. 3 if the ITS is less than the TS_action. In some cases, the TS_action for one or more regions can be set by a secure processor to specify what kind of action needs to be taken against each master. As shown in FIG. 3, a TS_action may comprise a 2-bit binary value, including, for example, 00, 01, or 10. For example, an ITS may be less than TS_threshold. In some examples, when TS_action is 2′b00, the TSM generates an error and the memory transaction is not completed. In some examples, when TS_action is 2′b01, the secure processor interrupts the transaction. In some examples, when TS_action is 2′b10, the secure processor is interrupted and the ITS is decremented. If none of the TS_action is triggered, then the memory transaction is continued. For example, an ITS may be greater than or equal to TS_threshold. In such examples, the memory transaction is continued.

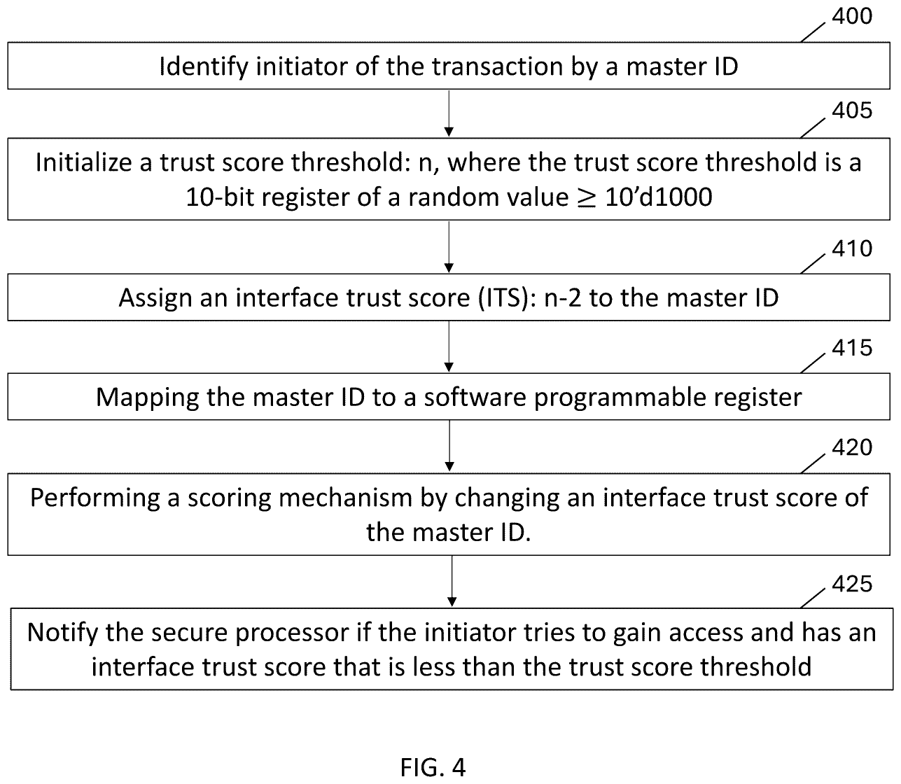

Also provided herein are methods for monitoring activity by a TSM. A method of monitoring activity by a TSM can comprise one or more operations. An exemplary method for providing device security using a TSM is provided in FIG. 4. In some cases, a method for monitoring activity comprises identifying an initiator of a transaction by a master ID 400. Each master can be tagged with a master ID so the TSM can identify the initiator. In some examples, the master ID comprises a unique ID. In some examples, a unique ID comprises a multi-bit value, or a hexadecimal representation, as provided herein.

In some instances, at reset de-assertion, a trust score threshold corresponding to one or more regions of the memory is initialized 405. The trust score threshold n may comprise a random value. In some examples, the random value may comprise a 10-bit register. In some examples, the 10-bit register is greater than or equal to 10′d1000. In some instances, at reset de-assertion, an interface trust score (ITS) is assigned to a master ID 410. The ITS may comprise the TS_threshold minus an integer value, for example, TS_threshold minus an integer value. The integer value can, in some examples, comprise 2. The descriptors, including the ITS or the TS_threshold, may hold a binary value, as described herein.

In some cases, the method for monitoring activity comprises mapping the master ID to a software programmable register 415. The software programmable register can comprise an address of a memory or a memory region, as described herein. In some examples, a software programmable register can comprise a start address or an end address of a memory. In some examples, a software programmable register can comprise a start address or an end address of a memory region, where the memory may be subdivided into N regions (e.g., N=1, 2, 3, 4, 5, 6, 8, 10, 12, 15, 16, 20, 25, 50, 75, 100). In some instances, the master ID is mapped to a software programmable register to assess whether the master is accessing its dedicated memory region, as described herein.

In some cases, the method for monitoring activity comprises performing a scoring mechanism 420. In some instances, the scoring mechanism comprises changing an interface trust score (ITS) of the master ID. In some examples, the changing the ITS comprises incrementing the ITS if the software programmable register comprises an address of a memory region that is dedicated for access by the master ID. In some examples, the changing the ITS comprises reducing the ITS if the software programmable register comprises an address of a memory region that is dedicated for access by another master ID.

In some cases, the method comprises notifying the secure processor if the initiator (master) tries to gain access to a region other than its dedicated memory region, has an interface trust score that is less than the trust score threshold, or both 425. In some instances, some or all of the masters can gain trust of the TSM over time. In some examples, a master gains trust of the TSM over time by accessing only its dedicated memory region.

### Certain Definitions

Unless otherwise defined, all technical terms used herein have the same meaning as commonly understood by one of ordinary skill in the art to which the present subject matter belongs.

As used in this specification and the appended claims, the singular forms “a,” “an,” and “the” include plural references unless the context clearly dictates otherwise. Any reference to “or” herein is intended to encompass “and/or” unless otherwise stated.

As used herein, the phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

### Computing System

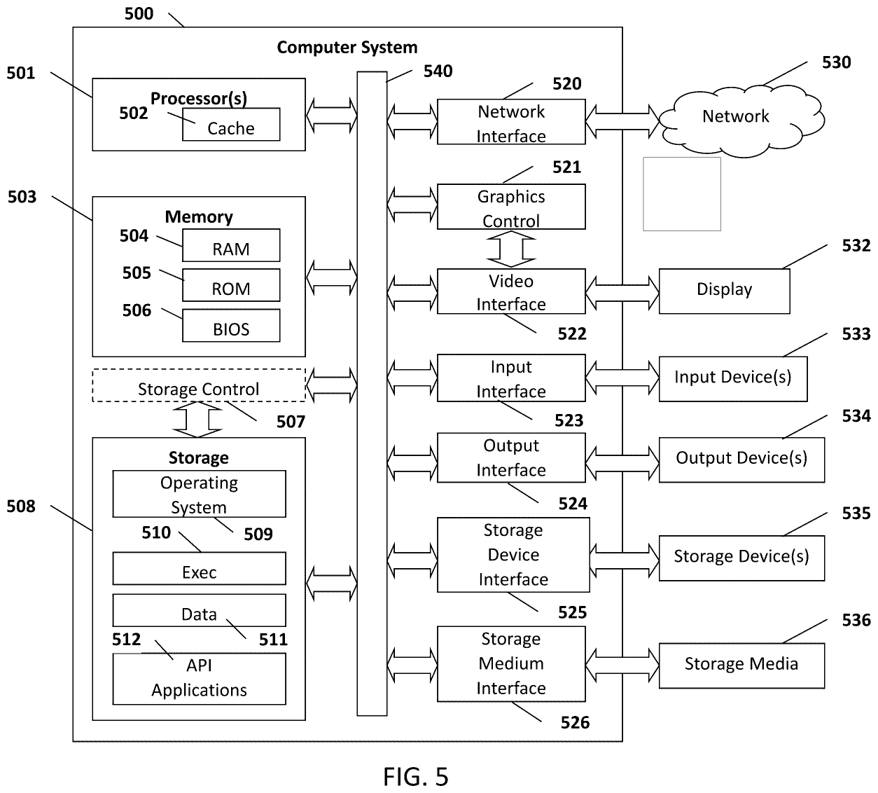

Referring to FIG. 5, a block diagram is shown depicting an exemplary machine that includes a computer system 500 (e.g., a processing or computing system) within which a set of instructions can execute for causing a device to perform or execute any one or more of the aspects and/or methodologies for static code scheduling of the present disclosure. The components in FIG. 5 are examples only and do not limit the scope of use or functionality of any hardware, software, embedded logic component, or a combination of two or more such components implementing particular embodiments.

Computer system 500 may include one or more processors 501, a memory 503, and a storage 508 that communicate with each other, and with other components, via a bus 540. The bus 540 may also link a display 532, one or more input devices 533 (which may, for example, include a keypad, a keyboard, a mouse, a stylus, etc.), one or more output devices 534, one or more storage devices 535, and various tangible storage media 536. All of these elements may interface directly or via one or more interfaces or adaptors to the bus 540. For instance, the various tangible storage media 536 can interface with the bus 540 via storage medium interface 526. Computer system 500 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 500 includes one or more processor(s) 501 (e.g., central processing units (CPUs), general purpose graphics processing units (GPGPUs), or quantum processing units (QPUs)) that carry out functions. Processor(s) 501 optionally contains a cache memory unit 502 for temporary local storage of instructions, data, or computer addresses. Processor(s) 501 are configured to assist in execution of computer readable instructions. Computer system 500 may provide functionality for the components depicted in FIG. 5 as a result of the processor(s) 501 executing non-transitory, processor-executable instructions embodied in one or more tangible computer-readable storage media, such as memory 503, storage 508, storage devices 535, and/or storage medium 536. The computer-readable media may store software that implements particular embodiments, and processor(s) 501 may execute the software. Memory 503 may read the software from one or more other computer-readable media (such as mass storage device(s) 535, 536) or from one or more other sources through a suitable interface, such as network interface 520. The software may cause processor(s) 501 to carry out one or more processes or one or more steps of one or more processes described or illustrated herein. Carrying out such processes or steps may include defining data structures stored in memory 503 and modifying the data structures as directed by the software.

The memory 503 may include various components (e.g., machine readable media) including, but not limited to, a random access memory component (e.g., RAM 504) (e.g., static RAM (SRAM), dynamic RAM (DRAM), ferroelectric random access memory (FRAM), phase-change random access memory (PRAM), etc.), a read-only memory component (e.g., ROM 505), and any combinations thereof. In some instances, the memory is subdivided into one or more regions, as provided herein. In some examples, the one or more regions comprises at least one address (e.g., start address, end address). The memory region addresses may be managed by a trust score manager (TSM) as software programmable registers, as provided herein. ROM 505 may act to communicate data and instructions unidirectionally to processor(s) 501, and RAM 504 may act to communicate data and instructions bidirectionally with processor(s) 501. ROM 505 and RAM 504 may include any suitable tangible computer-readable media described below. In one example, a basic input/output system 506 (BIOS), including basic routines that help to transfer information between elements within computer system 500, such as during start-up, may be stored in the memory 503.

Fixed storage 508 is connected bidirectionally to processor(s) 501, optionally through storage control unit 507. Fixed storage 508 provides additional data storage capacity and may also include any suitable tangible computer-readable media described herein. Storage 508 may be used to store operating system 509, executable(s) 510, data 511, applications 512 (application programs), and the like. Storage 508 can also include an optical disk drive, a solid-state memory device (e.g., flash-based systems), or a combination of any of the above. Information in storage 508 may, in appropriate cases, be incorporated as virtual memory in memory 503.

In one example, storage device(s) 535 may be removably interfaced with computer system 500 (e.g., via an external port connector (not shown)) via a storage device interface 525. Particularly, storage device(s) 535 and an associated machine-readable medium may provide non-volatile and/or volatile storage of machine-readable instructions, data structures, program modules, and/or other data for the computer system 500. In one example, software may reside, completely or partially, within a machine-readable medium on storage device(s) 535. In another example, software may reside, completely or partially, within processor(s) 501.

Bus 540 connects a wide variety of subsystems. Herein, reference to a bus may encompass one or more digital signal lines serving a common function, where appropriate. Bus 540 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 500 may also include an input device 533. In one example, a user of computer system 500 may enter commands and/or other information into computer system 500 via input device(s) 533. Examples of an input device(s) 533 include, but are not limited to, an alpha-numeric input device (e.g., a keyboard), a pointing device (e.g., a mouse or touchpad), a touchpad, a touch screen, a multi-touch screen, an audio input device (e.g., a microphone, a voice response system, etc.), or any combinations thereof. Input device(s) 533 may be interfaced to bus 540 via any of a variety of input interfaces 523 (e.g., input interface 523) including, but not limited to, serial, parallel, game port, USB, FIREWIRE, THUNDERBOLT, or any combination of the above.

In particular embodiments, when computer system 500 is connected to network 530, computer system 500 may communicate with other devices, specifically mobile devices and enterprise systems, distributed computing systems, cloud storage systems, cloud computing systems, and the like, connected to network 530. Communications to and from computer system 500 may be sent through network interface 520. For example, network interface 520 may receive incoming communications (such as requests or responses from other devices) in the form of one or more packets (such as Internet Protocol (IP) packets) from network 530, and computer system 500 may store the incoming communications in memory 503 for processing. Computer system 500 may similarly store outgoing communications (such as requests or responses to other devices) in the form of one or more packets in memory 503 and communicated to network 530 from network interface 520. Processor(s) 501 may access these communication packets stored in memory 503 for processing.

Examples of the network interface 520 include, but are not limited to, a network interface card, a modem, and any combination thereof. Examples of a network 530 or network segment 530 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 530, may employ a wired and/or a wireless mode of communication. In general, any network topology may be used.

Information and data can be displayed through a display. Information or data that is displayed may include a notification if a master (e.g., CPU) is trying to access a region of a memory that is dedicated for access by a different master (e.g., different CPU). In some instances, the information or data includes information of an action or operation taken by the trust score manager. Examples of a display 532 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 532 can interface to the processor(s) 501, memory 503, and fixed storage 508, as well as other devices, such as input device(s) 533, via the bus 540. The display 532 is linked to the bus 540 via a video interface 522, and transport of data between the display 532 and the bus 540 can be controlled via the graphics control 521. In still further embodiments, the display is a combination of devices such as those disclosed herein.

In addition to a display 532, computer system 500 may include one or more other peripheral output devices 534 including, but not limited to, an audio speaker, a printer, a storage device, and any combinations thereof. Such peripheral output devices may be connected to the bus 540 via an output interface 524. Examples of an output interface 524 include, but are not limited to, a serial port, a parallel connection, a USB port, a FIREWIRE port, a THUNDERBOLT port, and any combinations thereof.

In addition or as an alternative, computer system 500 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, server computers, desktop computers, laptop computers, notebook computers, netbook computers, netpad computers, handheld computers, Internet appliances, mobile smartphones, and tablet computers. Those of skill in the art will also recognize that select televisions, video players, and digital music players with optional computer network connectivity are suitable for use in the system described herein. Suitable tablet computers, in various embodiments, include those with booklet, slate, and convertible configurations, known to those of skill in the art.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD, Linux, Apple Mac OS X Server, Oracle Solaris, Windows Server, and Novell NetWare. Those of skill in the art will recognize that suitable personal computer operating systems include, by way of non-limiting examples, Microsoft Windows, Apple Mac OS X, UNIX, and UNIX-like operating systems such as GNU/Linux. In some embodiments, the operating system is provided by cloud computing.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft.NET or Ruby on Rails (RoR). In some embodiments, a web application utilizes one or more database systems including, by way of non-limiting examples, relational, non-relational, object oriented, associative, XML, and document oriented database systems. In further embodiments, suitable relational database systems include, by way of non-limiting examples, Microsoft SQL Server, mySQL, and Oracle. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or extensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash ActionScript, JavaScript, or Silverlight. In some embodiments, a web application is written to some extent in a server-side coding language such as Active Server Pages (ASP), ColdFusion, Perl, Java, JavaServer Pages (JSP), Hypertext Preprocessor (PHP), Python, Ruby, Tcl, Smalltalk, WebDNA, or Groovy. In some embodiments, a web application is written to some extent in a database query language such as Structured Query Language (SQL). In some embodiments, a web application integrates enterprise server products such as IBM Lotus Domino. In some embodiments, a web application includes a media player element. In various further embodiments, a media player element utilizes one or more of many suitable multimedia technologies including, by way of non-limiting examples, Adobe Flash, HTML 5, Apple QuickTime, Microsoft Silverlight, Java, and Unity.

### Mobile Application

In some embodiments, a computer program includes a mobile application provided to a mobile computing device. In some embodiments, the mobile application is provided to a mobile computing device at the time it is manufactured. In other embodiments, the mobile application is provided to a mobile computing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java, JavaScript, Pascal, Object Pascal, Python, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and PhoneGap. Also, mobile device manufacturers distribute software developer kits including, by way of non-limiting examples, iPhone and iPad (iOS) SDK, Android SDK, BlackBerry SDK, BREW SDK, Palm OS SDK, Symbian SDK, webOS SDK, and Windows Mobile SDK.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java, Lisp, Python, Visual Basic, and VB .NET, or combinations thereof. Compilation is often performed, at least in part, to create an executable program. In some embodiments, a computer program includes one or more executable complied applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®. In some embodiments, the toolbar comprises one or more web browser extensions, add-ins, or add-ons. In some embodiments, the toolbar comprises one or more explorer bars, tool bands, or desk bands.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected computing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called microbrowsers, mini-browsers, and wireless browsers) are designed for use on mobile computing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of, by way of examples, assets and information of owners. In various embodiments, suitable databases include, by way of non-limiting examples, relational databases, non-relational databases, object-oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### EXAMPLES

The following illustrative examples are representative of embodiments of the software applications, systems, and methods described herein and are not meant to be limiting in any way.

### Example 1—Memory Access by a Master With a Nearby Trust Score Manager

A dynamic random-access memory (DRAM) is subdivided into 16 regions as shown in FIG. 2. Each of the 16 regions can be accessed by a separate master (e.g., separate CPU). Each master can access its respective region, and cannot access a region other than its respective region. Each master is tagged with a unique identifier (ID) in order for the trust score manager (TSM) to identify an initiator of the transaction (i.e., master ID). 32 software programmable registers are given to the TSM located nearby the DRAM. The 32 software programmable registers include start addresses and end addresses for each of the 16 regions of the DRAM.

The TSM includes a logic that has a scoring mechanism to detect whether a master is compromised and is accessing DRAM out of its scope. The TSM also has 16 10-bit registers each dedicated for a master. Those register will be uninitialized registers and at time 0, the registers will get initialized with some random values (e.g., TS_threshold). The logic ensures a TS_threshold value is never less than 10′d1000 and holds some significant value. On reset de-assertion, a TS_threshold value is assigned and ITS will be TS_threshold minus 2, initially. During the bring up, none of the interfaces are trusted and all master have to gain the trust of TSM overtime.

For example, region 1 is enabled with TSM, which is dedicated for a CPU. On reset de-assertion, it will be initialized with a 10-bit TS_threshold value (e.g., n) and it will have ITS value of the TS_threshold minus an integer value of 2 (e.g., n-2). At an initial stage, the TSM does not trust the CPU as the ITS value is less than the threshold. Now, if the CPU tries to access the memory out of its scope, the TSM will reduce the ITS of the CPU and notify the secure processor. Otherwise, the TSM will increment the ITS score of CPU.

While preferred embodiments of the present subject matter have been shown and described herein, it will be obvious to those skilled in the art that such embodiments are provided by way of example only. Numerous variations, changes, and substitutions will now occur to those skilled in the art without departing from the present subject matter. It should be understood that various alternatives to the embodiments of the present subject matter described herein may be employed in practicing the present subject matter.

What is claimed is:

1. A computer-implemented method of monitoring suspicious activity by a trust score manager (TSM) comprising:
(a) identifying a transaction initiated by a master to access a region of a memory, wherein the master comprises a master identification (ID), and wherein each region of the memory comprises a dedicated master access managed in part by one or more software programmable registers of the TSM;
(b) mapping the master ID to a software programmable register of the one or more software programmable registers; and
(c) performing a scoring mechanism by the TSM, wherein the scoring mechanism comprises changing an interface trust score (ITS) of the master ID, comprising:
(i) incrementing the ITS if the software programmable register comprises an address of a memory region that is dedicated for access the master ID; or
(ii) reducing the ITS if the software programmable register comprises an address of a memory region that is dedicated for access by another master ID.

2. The method of claim 1, further comprising initializing one or more trust score thresholds to one or more regions of the memory.

3. The method of claim 2, wherein initializing the one or more trust score thresholds occurs prior to (b).

4. The method of claim 1, further comprising assigning one or more ITSs to one or more master IDs.

5. The method of claim 4, wherein the assigning one or more ITSs occurs prior to (c).

6. The method of claim 4, wherein one or more ITSs are assigned on reset de-assertion.

7. The method of claim 4, wherein one or more ITSs comprise the one or more trust score thresholds minus an integer value.

8. The method of claim 7, wherein the integer value is 2.

9. The method of claim 1, further comprising notifying a secure processor if the ITS is less than a trust score threshold of the memory region.

10. The method of claim 2, wherein the one or more trust score threshold comprises a 10-bit register.

11. The method of claim 10, wherein the 10-bit register of a random value.

12. The method of claim 11, wherein the random value is greater than or equal to 10′d1000.

13. The method of claim 1, wherein the one or more software programmable registers comprise one or more start addresses or one or more end addresses of the one or more regions of the memory.

14. The method of claim 1, wherein the one or more software programmable registers are programmed by a secure processor.

15. The method of claim 1, wherein the master gains trust of the TSM over time.

16. A computer-implemented system comprising:
(a) a memory comprising one or more regions, wherein the one or more regions comprise one or more addresses; and
(b) at least one processor providing a trust score manager (TSM), wherein the TSM comprises:
(i) one or more software programmable registers corresponding to the one or more addresses;
(ii) one or more trust score threshold for the one or more memory regions; and
(iii) one or more interface trust scores for one or more master identifications (IDs).

17. The system of claim 16, wherein the one or more addresses comprise one or more start addresses, one or more end addresses, or both of the one or more memory regions.

18. The system of claim 16, wherein the TSM performs at least one operation, wherein the at least one operation comprises one or more of:
(A) identifying a transaction initiated by a master to access a memory region, wherein the master comprises a master identification (ID);
(B) initializing the one or more trust score thresholds on reset de-assertion;
(C) assigning the one or more interface trust scores (ITSs) on reset de-assertion;
(D) mapping the master ID to a software programmable register of the one or more software programmable registers;
(E) performing a scoring mechanism when the transaction is initiated; and
(F) notifying a secure processor if an interface trust score of the master ID is less than a trust score threshold of a memory region that the master is trying to access.

19. The system of claim 18, wherein the one or more trust score thresholds comprises a random value.

20. The system of claim 19, wherein the random value is greater than or equal to 10′d1000.

21. The system of claim 17, wherein the one or more ITSs comprise the one or more trust score thresholds minus an integer value.

22. The system of claim 21, wherein the integer value is 2.

23. The system of claim 16, wherein the scoring mechanism comprises changing an ITS of the master ID, wherein changing the ITS comprises:
(1) incrementing the ITS if the software programmable register comprises an address of a memory region that is dedicated for access the master ID; or
(2) reducing the ITS if the software programmable register comprises an address of a memory region that is dedicated for access by another master ID.

24. The system of claim 16, wherein the master comprises a CPU.

25. One or more non-transitory computer-readable storage media encoded with instructions executable by one or more processors to provide an application for monitoring suspicious activity by performing operations comprising:
(a) identifying a transaction initiated by a master to access a region of a memory, wherein the master comprises a master identification (ID), and wherein each region of the memory comprises a dedicated master access managed in part by one or more software programmable registers of a trust score manager (TSM);
(b) mapping the master ID to a software programmable register of the one or more software programmable registers; and
(c) performing a scoring mechanism by the TSM, wherein the scoring mechanism comprises changing an interface trust score (ITS) of the master ID, comprising: incrementing the ITS when the software programmable register comprises an address of a memory region that is dedicated for access the master ID; or reducing the ITS when the software programmable register comprises an address of a memory region that is dedicated for access by another master ID.
